(19) United States
(12) Patent Application Publication
(10) Pub. No.: US 2024/0224999 A1
(43) Pub. Date: Jul. 11, 2024

(54) METABOLIC INHIBITORS FOR CONTROLLING BIOFILM

(71) Applicant: MC (US) 3 LLC, Wilmington, DE (US)

(72) Inventors: Olivia Stenzel, Wilmington, DE (US); Hiteshkumar Dave, Wilmington, DE (US)

(21) Appl. No.: 18/286,254

(22) PCT Filed: Apr. 15, 2022
(86) PCT No.: PCT/US2022/025027

§ 371 Date: Oct. 10, 2023

Related U.S. Application Data
(60) Provisional application No. 63/175,406, filed on Apr. 15, 2021.

(51) Int. Cl. A01N 43/42; A01N 37/28; A01P 1/00; C02F 1/50; C02F 101/10; C09K 8/035; C09K 8/532

(52) U.S. Cl. CPC A01N 43/42; A01N 37/28; A01P 1/00; C02F 1/50; C09K 8/035; C09K 8/532; C02F 2101/101; C09K 2208/20

(57) ABSTRACT

Disclosed herewith is a method of using N-hydroxycarboxamide compound based metabolic inhibitor composition, which has demonstrated efficacy for controlling biofilms formed by sulfate reducing prokaryotes. This composition is suitable for use in downhole, drilling and exploration application environments and in equipment like rigs, semi-submersibles, storage and base structures. It can also be used in other harsh environment applications, including mining, industrial extraction of metals and sewage treatment, as well as non-harsh environment applications.

### FIELD OF INVENTION

This invention relates to the field of using N-hydroxycarboxamide based metabolic inhibitor composition, having demonstrated efficacy for controlling biofilms formed by sulfate reducing prokaryotes, in downhole, and other harsh drilling and exploration environment applications and in equipment like rigs, semi-submersibles, storage and base structures.

### BACKGROUND OF THE INVENTION

A biofilm is composed of living, reproducing microorganisms, such as bacteria, that exist as a colony, or community. In other words, biofilms are alive and have a complex social structure that both protects them and allows them to grow. A biofilm forms when certain microorganisms (for example, some types of prokaryotes like bacteria) adhere to the surface of some object in a moist environment and begin to reproduce. The microorganisms form an attachment to the surface of the object by secreting a slimy, glue-like substance.

Water-injection systems are frequently contaminated by bacteria that can cause severe plugging of surface and downhole equipment and injection-well formations and generate H₂S that can indirectly cause pitting corrosion. Biogenic sulfide production (biogenic souring) results from sulfate-reducing prokaryotes (SRP) or other sulfidogenic bacterial activity. In addition to the corrosion of metal surfaces, H₂S is both toxic and explosive. Thus, a need exists for an effective method to control the formation of biofilms and reduce the growth of or kill the microbes responsible for the same.

According to Videla, H. A. in Prevention and control of biocorrosion. Int. Biodeterior. Biodegrad. 2002, 49, 259-270 and Pichtel, J. in Oil and gas production wastewater: Soil contamination and pollution prevention. Appl. Environ. Soil Sci. 2016, 2016, to counter these effects, bacterial growth inwater-injection systems are controlled mainly by chemical biocides, such as glutaraldehyde and quaternary ammonium salts.

In Stewart, P. S.; Costerton, J. W. Antibiotic resistance of bacteria in biofilms. Lancet 2001, 358, 135-138, several other water-based fluids used in oil and natural gas drilling and production operations benefit from the use of biocides, as well as the water holding tanks. However, biocides may fail because of difficulties in penetrating bacterial biofilms and also due to bacterial biocide-resistance. Hence, alternative biocides against harmful bacteria, with a particular focus on SRB control, are of great interest to the petroleum industry.

Hydroxamic acids are well known in literature to be useful as histone deacetylase inhibitor drugs with potent antimalarial activity. They have also been reported in literature for use in drugs for their therapeutic potential in treating various tumors and cancers, for example, as described in chapter “Therapeutic Areas II: Cancer, Infectious Diseases, Inflammation & Immunology and Dermatology”, by H. Weinmann, E. Ottow, in Comprehensive Medicinal Chemistry II, 2007.

In U.S. Pat. No. 5,279,967A, use of Naphthalimide derivatives in oil and gas industry N,N′-dialkyl-4-amino-1,8-naphthalimides has been disclosed. These compounds have been used to identify and trace hydrocarbons using the fluorescent labeling compounds

U.S. Pat. No. 6,358,746B1 discloses the use of Naphthalimide derivatives in Industrial Water Solutions, for application as a fluorescent tracer in water systems such as in the oil industry.

It has been established that hydroxamate based compounds can be used to control biofilms formed by sulfate reducing prokaryotes (SRP). However, the disadvantage is that most hydroxamates do not have the stability and efficacy to function in harsh environments. The problem to be solved is to provide a method of using a composition that can control biofilm formation by a sulfate reducing prokaryote.

### SUMMARY OF THE INVENTION

In a first embodiment, the invention is a method of controlling a biofilm formed by sulfate reducing prokaryotes comprising:
(i) using a composition comprising at least one compound having structure 1:

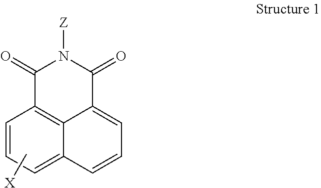

wherein, Z: C(O)NHOH or C(Y)(R),
Y: Hydrogen, C₆ aromatic, C₆ heteroaromatic, C₆ aliphatic cyclic or alicyclic group, hetero group such as nitro, phosphate, hydroxyl,
R: Carbon (n=1-10) linear or branched chain compound terminated with an N-hydroxycarboxamide, carboxylic acid, alcohol or N-hydroxycarboxamide,
X: Hydrogen, OH, NH₂, halogen, carbon 1-3 n or branched chain; and
(ii) contacting the composition with the sulfate reducing prokaryote, to control the biofilm formation.

In a second embodiment, the invention is a method of controlling a biofilm formed by sulfate reducing prokaryotes comprising:
(i) using a composition comprising at least one compound having structure 2:

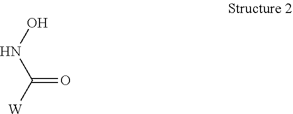

wherein, W: Hydrogen, carbon (n=1-10) linear or branched chain compound that is optionally terminated with a hydroxyamide, carboxylic acid, alcohol or N-hydroxycarboxamide, C₆ aromatic, C₆ heteroaromatic, C₆ aliphatic cyclic or alicyclic group; and
(ii) contacting the composition with the sulfate reducing prokaryote, to control the biofilm formation.

This composition has demonstrated efficacy for controlling biofilms. This composition is suitable for use in downhole, drilling and exploration application environments and in equipment like rigs, semi-submersibles, storage and base structures. It can also be used in other harsh environment applications, including mining, industrial extraction of metals and sewage and wastewater treatment and other industrial water and water containing/contaminated systems, as well as non-harsh environment systems.

### DETAILED DESCRIPTION OF THE INVENTION

The present invention is directed towards methods for controlling biofilms that are formed by sulfate reducing prokaryotes, like bacteria, in for example crude oil or hydrocarbon containing systems. This invention highlights the usage of N-hydroxycarboxamide compounds disclosed herewith. This method is useful in Oil and Gas applications and downhole oilfield reservoirs. This composition could also have applications in non-Oil and Gas applications in controlling other problematic prokaryotes like bacteria.

Water injection is the most common method for secondary petroleum recovery. However, water injection has been associated with biotic reservoir souring leading to the production of increased concentrations of hydrogen sulfide (H₂S) in produced fluids. Primary cause of biotic souring is related to biofilm formation by sulfate reducing prokaryotes. This invention focuses on a new class of metabolic inhibitor compounds which has shown effectiveness against controlling biofilm formed by SRP.

The sulfur utilizing prokaryote can comprise a genus or species of bacteria and/or archaea capable of reducing sulfur compounds. The biofilm formed by the SRP is controlled by at least about 25 percent, depending on the amount of the composition used and the type of N-hydroxycarboxamide compound used in the composition. Table 3 lists some of the compounds that can be used in the compositions disclosed as embodiments of the invention.

In a first embodiment, the invention is a method of controlling a biofilm formed by sulfate reducing prokaryotes comprising:
(iii) using a composition comprising at least one compound having structure 1:

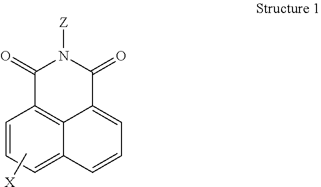

wherein, Z: C(O)NHOH or C(Y)(R),
Y: Hydrogen, C₆ aromatic, C₆ heteroaromatic, C₆ aliphatic cyclic or alicyclic group, hetero group such as nitro, phosphate, hydroxyl,
R: Carbon (n=1-10) linear or branched chain compound terminated with an N-hydroxycarboxamide, carboxylic acid, alcohol or N-hydroxycarboxamide,
X: Hydrogen, OH, NH₂, halogen, carbon (n=1-3) linear or branched chain compound; and
(iv) contacting the composition with the sulfate reducing prokaryote, to control the biofilm formation.

In a second embodiment, the invention is a method of controlling a biofilm formed by sulfate reducing prokaryotes comprising:
(ii) using a composition comprising at least one compound having structure 2:

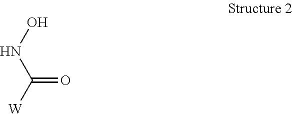

wherein, W: Hydrogen, carbon (n=1-10) linear or branched chain compound that is optionally terminated with a hydroxyamide, carboxylic acid, alcohol or N-hydroxycarboxamide, C₆ aromatic, C₆ heteroaromatic, C₆ aliphatic cyclic or alicyclic group; and
(iv) contacting the composition with the sulfate reducing prokaryote, to control the biofilm formation.

To understand the biofilm control efficacy of the N-hydroxycarboxamide compounds as defined by structures 1 and 2, several compounds were tested and are disclosed in Table 3. For the testing procedures, the compounds were dissolved in DMSO, to form solutions in the concentration range of about 1 to about 200 ppm for efficacy testing.

Strains of commonly found bacteria were used for testing the efficacy of the compounds, viz. Desulfovibrio alaskensis and Desulfovibrio vulgaris. Media for the cultures was also prepared by using a standard method. The cultures were aseptically used and incubated under anaerobic conditions. They were plated with an MBEC (minimal biofilm eradication concentration) lid, to allow for biofilm growth. The MBEC plates had a 2-day exposure time. Then the plates were rinsed, sonicated and enumerated. These enumerations were grown for 5-days for the readings.

The compounds C1, C12 and C16 were tested individually to understand each of their efficacies in controlling the biofilm formation by the microorganism strains, under standard temperature and pressure conditions. The results for C1 are discussed in Table 4. The efficacy of compounds C12 and C16 are disclosed in Table 5. It can be noted that these compounds did show significant activity in controlling biofilms, and so, these compounds are effective.

Surprisingly, amongst the tested compounds, compound C1 showed the highest efficacy when used in the composition for controlling biofilm formation. The compound showed efficacy when used in a concentration range of about 0.2 to about 200 ppm, preferably in a concentration range of about 1 ppm to about 20 ppm and most preferably in a concentration range of about 1 ppm to about 5 ppm. The compounds C12 and C16 also exhibited efficacy when used in the composition for controlling biofilm formation.

Therefore, to further analyze the efficacy of compound C1, comparative testing was done against two commercial products Commercial products (1) formulated 50 wt % THPS and (2) formulated 42.5 wt % glutaraldehyde and 7.5 wt % ADBAC (Alkyl (C14 50%, C12 40%, C16 10%) dimethyl benzyl ammonium chloride) were obtained from open market, which are used for a similar purpose. It was found that the composition containing compound C1 preferentially controlled biofilm formation. C1 showed a surprising efficacy in completely killing the microorganism strain Desulfovibrio alaskensis by using metabolic inhibition. These results are disclosed in Table 6.

In the method described herein, the composition showed efficacy at controlling the biofilm formation at a contact time of about 6 hours. The composition showed efficacy at higher contact times of about 12 and about 18 hours and at about 2 days as well.

In the method described herein, the composition is preferably used to control biofilms formed in a hydrocarbon containing system, which can be a downhole, a subterranean hydrocarbon-containing formation, a well, a pipeline, a fluid separation vessel, a floating production storage vessel, an offloading vessel, a refinery, or a storage system.

In the method described herein, the composition can further be administered along with a traditional biocide, or a combination of biocides thereof, for synergistic effects in controlling bacteria.

The composition can effectively control biofilms formed in harsh environments like oil and gas downhole applications, subterranean hydrocarbon containing formation, functional fluids, oil and gas reservoirs and production systems, in equipment like rigs, semi-submersibles, storage and base structures, oil and gas transportation and storage systems, mining, industrial extraction of metals etc. This composition can also be effective against problematic prokaryotes like bacteria, present in non-harsh environments like cooling and heating systems, paper and pulp mills, membrane and filtration systems, as well as in material preservation, gas or liquid produced or used in a waste-water process, farming or slaughter house, land-fill, sewage collection system, municipality waste-water plant, coking coal process, or biofuel process.

### Terms and Definitions

A number of terms have been used while describing the invention. Unless otherwise specified, the terms are defined as:

As used herein, the articles “a”, “an”, and “the” preceding an element or component of the invention are intended to be nonrestrictive regarding the number of instances (i.e., occurrences) of the element or component. Therefore “a”, “an”, and “the” should be read to include one or at least one, and the singular word form of the element or component also includes the plural unless the number is obviously meant to be singular.

As used herein, the term “comprising” means the presence of the stated features, integers, steps, or components as referred to in the claims, but that it does not preclude the presence or addition of one or more other features, integers, steps, components or groups thereof. The term “comprising” is intended to include embodiments encompassed by the terms “consisting essentially of” and “consisting of”. Similarly, the term “consisting essentially of” is intended to include embodiments encompassed by the term “consisting of”. As used herein, the term “about” modifying the quantity of an ingredient or reactant employed refers to variation in the numerical quantity that can occur, for example, through typical measuring and liquid handling procedures used for making concentrates or use solutions in the real world; through inadvertent error in these procedures; through differences in the manufacture, source, or purity of the ingredients employed to make the compositions or carry out the methods; and the like.

Where present, all ranges are inclusive and combinable. For example, when a range of “1 to 5” is recited, the recited range should be construed as including ranges “1 to 4”, “1 to 3”, “1-2”, “1-2 & 4-5”, “1-3 & 5”, and the like.

As used herein, Absorbance relates to measure of the capacity of a substance to absorb incident light of a specified wavelength. Absorption is used to quantify specific substances.

As used herein, Controlling relates to the ability of the tested compounds in remediating or inhibiting or preventing the growth of biofilms formed by SRPs. As used herein, Efficacy relates to the ability of tested compounds in inhibiting H₂S.

As used herein, Enumeration plates relate to giving the log growth of a microbial sample by inoculating plates containing fresh media and serial diluting ten-fold. These plates are then incubated for a set amount of time. This helps to determine the number of microorganisms that were present in the original sample.

As used herein, Harsh environment relates to the presence of extreme conditions, for example, extreme high or low temperature, extreme high or low pressure, high or low content of oxygen or carbon dioxide in the atmosphere; high levels of radiation, absence of water; the presence of sulfur, petroleum and natural gases, where it is very hard for life forms to survive.

As used herein, inhibition of hydrogen sulfide (H₂S) production relates to reducing H₂S levels in the harsh environment by either selectively inhibiting sulfate reducing pathways or controlling sulfate reducing bacteria population by effective treatment strategies.

As used herein, Optical density (OD) relates to the measure of absorbance and is defined as the ratio of the intensity of light falling upon a material and the intensity transmitted.

When a parameter is given either as a range, preferred range, or a list of upper preferable values and lower preferable values, this is to be understood as specifically disclosing all ranges formed from any pair of any upper range limit or preferred value and any lower range limit or preferred value, regardless of whether ranges are separately disclosed. Where a range of numerical values is recited herein, unless otherwise stated, the range is intended to include the endpoints thereof, and all integers and fractions within the range. The scope of the invention is not intended to be limited to the specific values and examples as recited in the specification.

### EXAMPLES

### Example 1: Efficacy of Compounds Against Biofilms Comprising Sulfate Reducing Bacteria (SRB)

### Stock Solution Preparation

Compounds tested for biofilm efficacy were purchased from ChemBridge Corporation and Sigma Aldrich. Compounds were used as received.

Compounds' stock solutions were prepared by dissolving compounds in dimethyl sulfoxide (DMSO). Commercial products (1) formulated 50 wt % THPS and (2) formulated 42.5 wt % glutaraldehyde and 7.5 wt % ADBAC (Alkyl (C14 50%, C12 40%, C16 10%) dimethyl benzyl ammonium chloride) were obtained from open market.

### Media Preparation

All the ingredients for media preparation were purchased from Fisher Scientific and used as received.

TABLE 1
Preparation of ATCC MB1250 media

| Chemical | Amount (g) |
|---|---|
| MgSO₄ | 2.0 |
| Na-Citrate | 5.0 |
| CaSO₄ × 2H₂O | 1.0 |
| NH₄Cl | 1.0 |
| K₂HPO₄ | 0.5 |
| Na-Lactate | 3.5 |
| Yeast Extract | 1.0 |
| NaCl | 25.0 |
| DI H₂O | 961.0 |

Media's pH was adjusted to 7.5. 600 μL resazurin and 0.1 g/L Na-thioglycolate (Sigma Aldrich) were added immediately before autoclaving.

TABLE 2
Procedure for SRB2-LA media preparation
Solution A

| | | |
|---|---|---|
| K₂HPO₄ | 3.0 | g |
| NH₄Cl | 1.0 | g |
| Na₂SO₄ | 0.5 | g |
| Yeast extract | 0.5 | g |
| NaCl | 6.25 | g |
| 0.13% Resazurin Solution | 0.6 | mL |
| Distilled water | 985 | mL |

Solution B

| | | |
|---|---|---|
| FeSO₄ × 7 H₂O | 0.1 | g |
| Distilled water | 10 | mL |
| Add 10 mL | | |

Solution C

| | | |
|---|---|---|
| CaCl₂ × 2 H₂O | 2.5 | g |
| Distilled water | 25 | mL |
| Add 1 mL | | |

Solution D

| | | |
|---|---|---|
| MgSO₄ × 7 H₂O | 10.0 | g |
| Distilled water | 20 | mL |
| Add 4 mL | | |

Solution E

| | | |
|---|---|---|
| Sodium Dithionite | 0.1 | g |
| Distilled water | 4 | mL |
| Add 1 mL | | |

Other components

| | | |
|---|---|---|
| Na-(DL)-Lactate (60% syrup) | 2.1 | g |

Dissolve the ingredients of each solution in the appropriate quantities of water. Bring Solution A to a boil for a few minutes then cool to room temperature while gassing with oxygen-free N₂ gas. Autoclave 20 min at 121° C. Solutions B, C, D, and E need to be sterile filtered and afterwards flushed with N₂. After autoclaving and cooling add Solutions B, C, D and E to Solution A. Add the Na-(DL)-Lactate to the resulting mixture of solutions. Adjust the pH to 7-7.4 with NaOH (10%).

### Stock Culture Preparation

A lyophilized Desulfovibrio alaskensis 14563, Desulfovibrio vulgaris 29579 pure cultures received from ATCC were resuspended individually in 500 ul of MB 1250. Aseptically, the content was transferred to a 5-mL tube of MB1250 medium. The cultures were incubated in an anaerobic chamber at 30° C. for 72 hrs. Subsequently, an individual stock culture with a final concentration of 25% glycerol were prepared by adding equal volumes of culture and 50% glycerol. 1 ml of the cultures were then transferred to 2-ml cryogenic vials and stored at −80° C. The purity of the stock cultures was evaluated through PCR, by amplifying the 16S rDNA region, and thus, it was verified that the original ATCC sample was a pure culture.

48-hour cultures of ATCC Desulfovibrio alaskensis 14563 and Desulfovibrio vulgaris 29579 were prepared in an anaerobic chamber. Each culture was prepared as a 1:10 culture by taking 1 milliliter (mL) of a pure culture and inoculating 9 milliliters (mL) of fresh SRB2-LA media. Prepared cultures were incubated at 30° C. and further diluted 1:100 in SRB2-LA media after incubation. They were grown for another 24 hours then diluted 1:10. The 1:10 dilution was plated with an MBEC (minimal biofilm eradication concentration) lid, which would allow for biofilm growth.

### MBEC Treatment Plates Preparation

Treatment plates were prepared by adding 180 μL of fresh phosphate buffer amended with 10% SRB2-LA media to each well. These wells were then dosed with the compounds of interest with a ppm range of 200 to 1 PPM. Edge wells were not used due to their inherent variability and evaporation of the media. Each experiment was done with at least three replicates for different treatments and non-treatment controls. After incubation of the MBEC plate, the MBEC lid was removed and added to a rinse plate containing phosphate buffer and 10% SRB2-LA. The lid was rinsed for 30 seconds then added to the treatment plate. The MBEC lids had 6 hours to 3 days of exposure time. After targeted exposure time, the plates were rinsed, sonicated, and enumerated. The rinse was done for 30 seconds in 10% SRB2-LA with phosphate buffer. Following the rinse, the lid was added to a plate with the same media and buffer mix and the plate was sonicated for 5 minutes. After five minutes, the lid was discarded, and each row of the plate was enumerated. These enumerations were grown for 5 days before being read.

TABLE 3
List of representative compounds.

| Compounds | Structure |
|---|---|
| C1 | 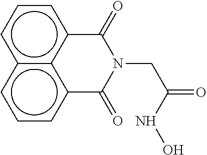 |
| C2 | 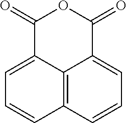 [SMILES: O=C1OC(=O)c2cccc3cccc1c23] |
| C3 | 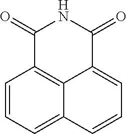 [SMILES: O=C1NC(=O)c2cccc3cccc1c23] |
| C4 | 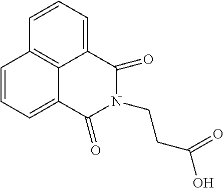 [SMILES: O=C(O)CCN1C(=O)c2cccc3cccc(c23)C1=O] |
| C5 | 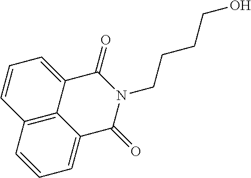 [SMILES: O=C1c2cccc3cccc(c23)C(=O)N1CCCCO] |
| C6 | 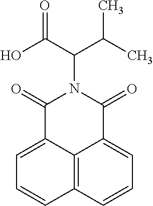 [SMILES: CC(C)C(C(=O)O)N1C(=O)c2cccc3cccc(c23)C1=O] |
| C7 | 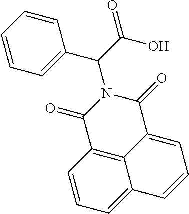 [SMILES: O=C(O)C(c1ccccc1)N1C(=O)c2cccc3cccc(c23)C1=O] |
| C8 | 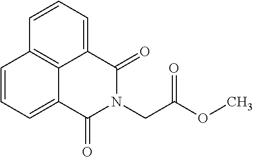 [SMILES: COC(=O)CN1C(=O)c2cccc3cccc(c23)C1=O] |
| C9 | 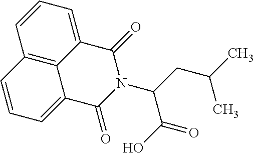 [SMILES: CC(C)CC(C(=O)O)N1C(=O)c2cccc3cccc(c23)C1=O] |
| C10 | 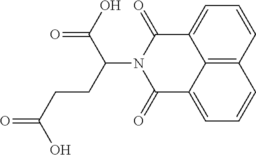 [SMILES: O=C(O)CCC(C(=O)O)N1C(=O)c2cccc3cccc(c23)C1=O] |
| C11 | 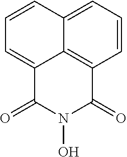 [SMILES: O=C1c2cccc3cccc(c23)C(=O)N1O] |
| C12 | 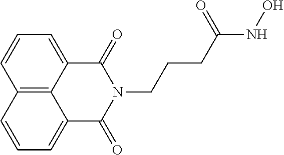 [SMILES: O=C(CCCN1C(=O)c2cccc3cccc(c23)C1=O)NO] |
| C13 | 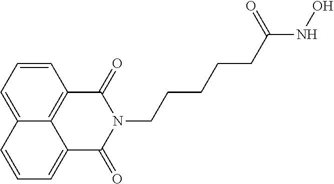 [SMILES: O=C(CCCCCN1C(=O)c2cccc3cccc(c23)C1=O)NO] |
| C14 | 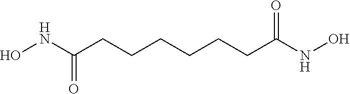 [SMILES: O=C(CCCCCCC(=O)NO)NO] |
| C15 | 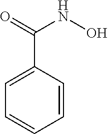 |
| C16 | 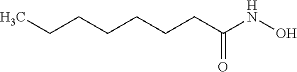 |

TABLE 4
Log (Growth) biofilm efficacy of compound C1 against SRBs.

| | Testing | | Compound | | |
|---|---|---|---|---|---|
| | Time | | Conc. | Log | Std. |
| Organisms | (Days) | | (PPM) | (Growth) | Dev. |
| Desulfovibrio | 3 | days | 200 | 0 | 0 |
| alaskensis | | | 100 | 0 | 0.4 |
| 14563 | | | 50 | 0 | 0.3 |
| | | | 0 | 4 | 1.0 |
| Desulfovibrio | 2 | days | 40 | 0 | 0 |
| alaskensis | | | 20 | 0 | 0 |
| 14563 | | | 10 | 0 | 0.5 |
| | | | 5 | 0 | 0 |
| | | | 0 | 5 | 0.5 |
| Desulfovibrio | 2 | days | 5 | 0 | 0.3 |
| alaskensis | | | 2.5 | 0 | 0.3 |
| 14563 | | | 1 | 0 | 0.3 |
| | | | 0 | 4 | 0.5 |
| Desulfovibrio | 2 | days | 200 | 1 | 0.6 |
| vulgaris | | | 100 | 0 | 0.7 |
| 29579 | | | 50 | 1 | 1 |
| | | | 25 | 1 | 1.2 |
| | | | 5 | 4 | 0.5 |
| | | | 0 | 5 | 0.7 |
| Desulfovibrio | 18 | hours | 50 | 0 | 0 |
| alaskensis | | | 25 | 0 | 0 |
| 14563 | | | 10 | 0 | 0 |
| | | | 5 | 0 | 0 |
| | | | 1 | 1 | 0.4 |
| | | | 0 | 5 | 0.5 |
| Desulfovibrio | 6 | hours | 50 | 1 | 0.5 |
| alaskensis | | | 25 | 1 | 0.5 |
| 14563 | | | 10 | 1 | 0.8 |
| | | | 5 | 2 | 0.4 |
| | | | 1 | 4 | 0.5 |
| | | | 0 | 4 | 0.6 |

TABLE 5
Log (Growth) biofilm efficacy of compounds
against Desulfovibrio alaskensis.

| | Testing | Compound | | |
|---|---|---|---|---|
| | Time | Conc. | Log | Std. |
| Compounds | (Days) | (PPM) | (Growth) | Dev. |
| C12 | 2 days | 200 | 0 | 0 |
| | | 100 | 0.3 | 0.5 |
| | | 50 | 1 | 1.2 |
| | | 25 | 0 | 0 |
| | | 5 | 1 | 1.4 |
| | | 0 | 5 | 0.6 |
| C16 | 2 days | 200 | 0 | 0 |
| | | 100 | 1 | 1.2 |
| | | 50 | 3 | 0.8 |
| | | 25 | 5 | 0.6 |
| | | 5 | 5 | 0.5 |
| | | 0 | 5 | 0.6 |

### COMPARATIVE EXAMPLE

TABLE 6
Log (Growth) biofilm efficacy of compound C1 against Desulfovibrio
alaskensis (performance comparison with commercial products).

| | Testing | Product | | |
|---|---|---|---|---|
| | Time | Conc. | Log | Std. |
| Products | (Days) | (PPM) | (Growth) | Dev. |
| C1 | 2 days | 50 | 0 | 0 |
| | | 25 | 0 | 0 |
| | | 15 | 0 | 0 |
| | | 5 | 0.5 | 1 |
| | | 0 | 4 | 0.75 |
| Formulated | 2 days | 50 | 3 | 1.2 |
| 50 wt % THPS | | 25 | 4 | 0.6 |
| | | 15 | 5 | 0.6 |
| | | 5 | 4 | 0.6 |
| | | 0 | 4 | 0.75 |
| Formulated | 2 days | 50 | 0 | 0 |
| 42.5 wt % | | 25 | 4 | 0.6 |
| glutaraldehyde | | 15 | 4 | 0.6 |
| and 7.5 wt % | | 5 | 4 | 0 |
| ADBAC* | | 0 | 4 | 0.75 |

*ADBAC- Alkyl (C14 50%, C12 40%, C16 10%) dimethyl benzyl ammonium chloride

1. A method of controlling biofilm formation by a sulfate reducing prokaryote comprising:
(i) providing a composition comprising at least one compound having structure 1: 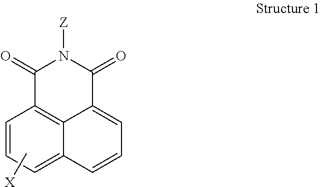
wherein, Z: C(O)NHOH or C(Y)(R),
Y: Hydrogen, C₆ aromatic, C₆ heteroaromatic, C₆ aliphatic cyclic or alicyclic group,
R: N-hydroxycarboxamide or carbon (n=1-10) linear or branched chain terminated with an N-hydroxycarboxamide, carboxylic acid, or alcohol,
X: Hydrogen, OH, NH₂, halogen, or carbon (n=1-3) linear or branched chain; and
(ii) contacting the composition with a sulfate reducing prokaryote to control the biofilm formation.

2. The method of claim 1, wherein the composition comprises the compound:

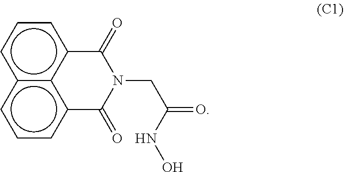

3. The method of claim 1, wherein the composition comprises the compound:

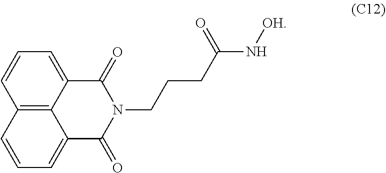 [SMILES: O=C(CCCN1C(=O)c2cccc3cccc(c23)C1=O)NO]

4. The method of claim 1, wherein the contacting step occurs in an application selected from the group consisting of oil and gas downhole application, subterranean hydrocarbon containing formation, functional fluids, oil and gas reservoirs and production systems, oil and gas transportation and storage systems, mining, industrial extraction of metals, cooling and heating systems, paper and pulp mills, membrane and filtration systems, material preservation, gas or liquid production, waste-water processing, farming or slaughter house, land-fill, sewage collection system, municipality waste-water plant, coking coal processing, and biofuel processing.

5. A method of controlling biofilm formation by a sulfate reducing prokaryote comprising:
(i) providing a composition comprising at least one compound having structure 2: 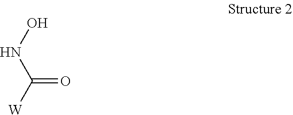
wherein, W: Hydrogen, C₆ aromatic, C₆ heteroaromatic, C₆ aliphatic cyclic or alicyclic, or carbon (n=1-10) linear or branched chain that is optionally terminated with a hydroxyamide, carboxylic acid, alcohol or N-hydroxycarboxamide; and
(ii) contacting the composition with a sulfate reducing prokaryote to control biofilm formation.

6. The method of claim 5, wherein the composition comprises the compound:

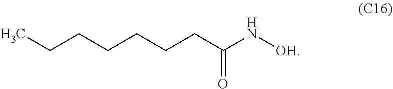

7. The method of claim 5, wherein the contacting step occurs in an application selected from the group consisting of oil and gas downhole application, subterranean hydrocarbon containing formation, functional fluids, oil and gas reservoirs and production systems, oil and gas transportation and storage systems, mining, industrial extraction of metals, cooling and heating systems, paper and pulp mills, membrane and filtration systems, material preservation, gas or liquid production, waste-water processing, farming or slaughter house, land-fill, sewage collection system, municipality waste-water plant, coking coal processing, and biofuel processing.

8. The method of claim 1, wherein
R: N-hydroxycarboxamide or carbon (n=1-10) linear or branched chain terminated with an N-hydroxycarboxamide.

9. The method of claim 1, wherein
Y: Hydrogen.

10. The method of claim 8, wherein
Y: Hydrogen.

11. The method of claim 1, wherein
X: Hydrogen.

12. The method of claim 8, wherein
X: Hydrogen.

13. The method of claim 9, wherein
X: Hydrogen.

14. The method of claim 10, wherein
X: Hydrogen.

15. The method of claim 1, wherein the composition comprises at least one compound of the structure:

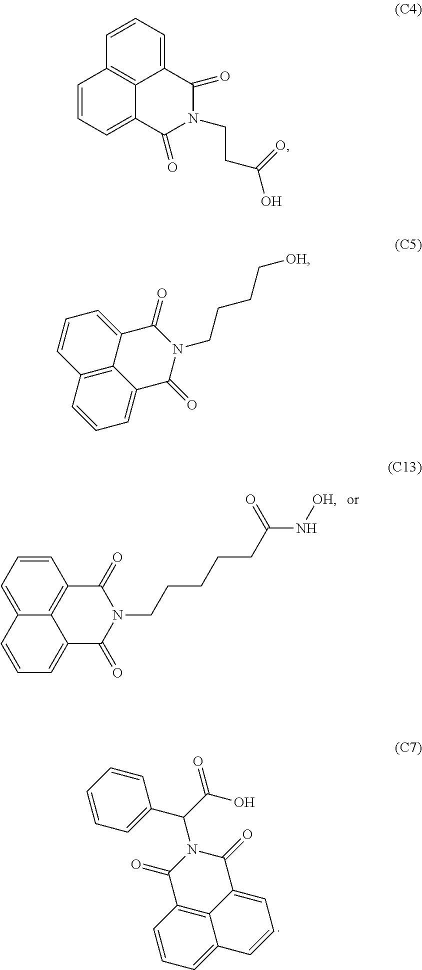 [SMILES: O=C(O)CCN1C(=O)c2cccc3cccc(c23)C1=O ; O=C1c2cccc3cccc(c23)C(=O)N1CCCCO ; O=C(CCCCCN1C(=O)c2cccc3cccc(c23)C1=O)NO ; O=C(O)C(c1ccccc1)N1C(=O)c2cccc3cccc(c23)C1=O]

16. The method of claim 5, wherein the composition comprises at least one compound of the structure:

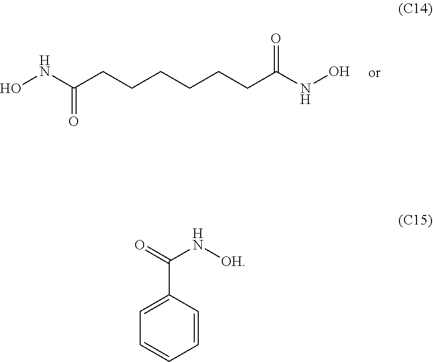 [SMILES: O=C(CCCCCCC(=O)NO)NO ; O=C(NO)c1ccccc1]

17. A method of controlling biofilm formation by a sulfate reducing prokaryote comprising:
(i) providing a composition comprising at least one compound of the structure: 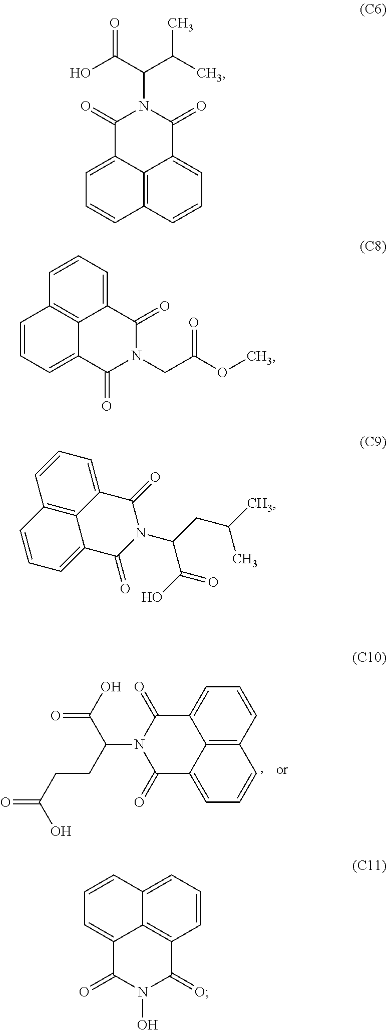 [SMILES: CC(C)C(C(=O)O)N1C(=O)c2cccc3cccc(c23)C1=O ; COC(=O)CN1C(=O)c2cccc3cccc(c23)C1=O ; CC(C)CC(C(=O)O)N1C(=O)c2cccc3cccc(c23)C1=O ; O=C(O)CCC(C(=O)O)N1C(=O)c2cccc3cccc(c23)C1=O ; O=C1c2cccc3cccc(c23)C(=O)N1O]
and
(ii) contacting the composition with a sulfate reducing prokaryote to control biofilm formation.

18. The method of claim 17, wherein the contacting step occurs in an application selected from the group consisting of oil and gas downhole application, subterranean hydrocarbon containing formation, functional fluids, oil and gas reservoirs and production systems, oil and gas transportation and storage systems, mining, industrial extraction of metals, cooling and heating systems, paper and pulp mills, membrane and filtration systems, material preservation, gas or liquid production, waste-water processing, farming or slaughter house, land-fill, sewage collection system, municipality waste-water plant, coking coal processing, and biofuel processing.
